(19) United States
(12) Patent Application Publication
(10) Pub. No.: US 2024/0009556 A1
(43) Pub. Date: Jan. 11, 2024

(54) CLOUD-BASED GAMING SYSTEM FOR SUPPORTING LEGACY GAMING APPLICATIONS WITH HIGH FRAME RATE STREAMS

(71) Applicant: GOOGLE LLC, Mountain View, CA (US)

(72) Inventors: Danny Hong, New York, NY (US); Sam John, Dublin, CA (US)

(21) Appl. No.: 18/217,776

(22) Filed: Jul. 3, 2023

Related U.S. Application Data
(63) Continuation of application No. PCT/US2022/036499, filed on Jul. 8, 2022.

(51) Int. Cl. A63F 13/355

(52) U.S. Cl. CPC A63F 13/355; A63F 2300/538

(57) ABSTRACT

A cloud-based gaming server renders a set of game frames at a first frame rate for a current client gaming session. An encoder of the server then determines whether the first frame rate is lower than a second frame rate associated with the encoder. In response to the first frame rate being lower, the encoder is configured to generate skip frames, with each skip frame indicating that a game frame of the set of game frames is to be repeated. The encoder also encodes the set of game frames to produce a set of encoded game frames and inserts one or more skip frames between two or more encoded game frames of the set of encoded game frames to produce a game stream. The server then packetizes the game stream and transmits the packetized game stream to a client system associated with the current client system.

### BACKGROUND

Cloud-based gaming platforms involve executing portions of or entire video game applications on remote servers to facilitate playing the video game application on a local client device. The remote servers provide, to the local client device, video rendered from executing video game applications as video streams over a network. In providing these video streams, the remote servers use various encoder operations to compress game frames. Additionally, the servers provide these video streams at a high frame rate to help support the interactivity of the local client device with the video game application.

However, many legacy video game applications render game frames at much lower frame rates than those provided by the video streams generated by the servers. To support such a legacy video game application, many systems upconvert the game frames rendered by the legacy gaming application by doubling one or more of the game frames for the video stream. However, doubling the game frames leads to several inefficiencies in the system as hardware resources of the server are wasted by doubling the frames, the hardware resources of the local client devices are wasted by decoding each frame twice, and the overall network bandwidth usage is wasted by transmitting each frame twice.

### SUMMARY

According to an example embodiment, a computer-implemented method can include, in response to a first frame rate associated with a set of game frames of a current client gaming session being lower than a second frame rate associated with an encoder, generating at least one skip frame including data that indicates (for a decoder receiving the game stream, e.g., a decoder in a client system) a game frame from the set of game frames is to be repeated. Further, the method can include encoding, by the encoder, the set of game frames to produce a game stream. Additionally, encoding the set of game frames can include inserting the skip frame in the game stream. The method may also include transmitting the game stream to a client system associated with the current client gaming session.

The method can also include packetizing a game stream. Packetizing a game stream can include generating a skip packet based on the skip frame (i.e., generating a packet for skip frame) and generating a frame packet based on an encoded game frame of the game stream (i.e., generating a packet for the encoded game frame). Further, the method can include transmitting the frame packet for a first time period and transmitting the skip packet for a second time period. Accordingly, the first time period can be equal to the second time period. Further, the method may include emptying at least a portion of a network buffer during the second time period.

In the method, inserting the skip frame can include inserting the skip frame between a first and second encoded game frame of the game stream. The skip frame may include data indicating the first encoded game frame is to be repeated. Further, in the method, the client system can be configured to repeat an encoded game frame of the game stream based on the skip frame. Also, the skip frame can be generated based on a codec associated with the encoder.

In another example embodiment, a computer-implemented method can include generating a plurality of skip frames based on a comparison of a first frame rate associated with a set of game frames for a current client gaming session and a second frame rate associated with an encoder. Each skip frame of the plurality of skip frames may include data indicating a game frame from the set of game frames is to be repeated. The method can further include encoding, by the encoder, the set of game frames to produce a game stream including a plurality of encoded game frames and the plurality of skip frames. Additionally, the method can include transmitting the game stream to a client system associated with the current client gaming session.

The method may also include packetizing the plurality of encoded game frames and the plurality of skip frames to produce a packetized game stream including a plurality of frame packets and a plurality of skip packets. The method can additionally include transmitting a frame packet of the plurality of frame packets to the client system for a first time period and transmitting a skip packet of the plurality of skip packets to the client system for a second time period. Accordingly, the first time period and the second time period may be equal. The method can also include emptying at least a portion of a network buffer during the second time period.

In the method, encoding the set of game frames can include inserting a skip frame of the plurality of skip frames between a first and second encoded game frame of the plurality of encoded game frames. The skip frame may indicate the first encoded game frame is to be repeated. Also in the method, the plurality of skip frames can be generated based on a codec associated with the encoder. Additionally, the plurality of skip frames can include a number of skip frames based on the comparison of the first frame rate associated with the set of game frames for a current client gaming session and a second frame rate associated with an encoder. The method may additionally include, in response to the first frame rate being lower than the second frame rate, generating the plurality of skip frames. Further, the method can include, in response to the first frame rate not being lower than the second frame rate, encoding, by the encoder, the set of game frames to produce a game stream including only the plurality of encoded game frames.

Generally, the first frame rate can indicate a frame rate of 30 frames per second. Additionally, the second frame rate can indicate a frame rate of 60 frames per second. Accordingly, the game stream can have a frame rate equal to the second frame rate.

In another example embodiment, a computer-implemented method can include receiving, at a client system associated with a current client gaming session, a packetized game stream including a frame packet and a skip packet. Further, the method can include decoding an encoded game frame indicated in the frame packet to produce a decoded game frame and, in response to displaying the decoded game frame on a display, repeating the decoded game frame on the display based on the skip packet.

In the method, the skip packet can indicate that the decoded game frame is to be repeated. Further, the packetized game stream can include a second frame packet and a second skip packet. Accordingly, the method can also include decoding a second encoded game frame indicated in the second frame packet to produce a second decoded game frame and, in response to displaying the second decoded game frame on the display, repeating the second decoded game frame on the display based on the second skip packet.

Additionally, the method can include rendering, at a server associated with the current client gaming session, a set of game frames at a first frame rate. Further, the method can include encoding, at an encoder of the server associated with the current client gaming session, the set of game frames to produce a set of encoded game frames and inserting a plurality of skip frames into the set of encoded game frames to produce a game stream associated with a second frame rate greater than the first frame rate. The method can also include packetizing, at the server associated with the current client gaming session, the game stream to produce the packetized game stream and transmitting the packetized game stream to the client system.

According to example embodiments, a cloud-based gaming system can include one or more cloud-based gaming servers communicatively coupled to one or more client systems. Each cloud-based gaming server can include one or more processors and a memory coupled to the one or more processors and storing executable instructions configured to manipulate the one or more processors to perform one or more of the methods disclosed herein.

According to additional example embodiments, a cloud-based gaming system can include a cloud-based gaming server that includes a network interface coupleable to a client system over a network and an encoder coupled to the network interface, the system configured to perform one or more methods disclosed herein.

According to further example embodiments, a cloud-based gaming system includes a client system configured for cloud-based gaming communicatively coupled to one or more cloud-based gaming servers. The client system can include one or more processors and a memory coupled to the one or more processors and storing executable instructions configured to manipulate the one or more processors to perform one or more methods disclosed herein.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a cloud-based gaming system configured to generate game streams with one or more skip frames, in accordance with some embodiments.

FIG. 2 is a block diagram of a computing device configured to encode and provide game streams including one or more skip frames within a cloud-based gaming system, in accordance with some embodiments.

FIG. 3 is a flow diagram of an example operation for encoding a game stream with one or more skip frames, in accordance with some embodiments.

FIG. 4 is a diagram of an example game stream with skip frames, in accordance with some embodiments.

FIG. 5 is a timing diagram of an example packetized game stream, in accordance with some embodiments.

FIG. 6 is an example method for generating a game stream with one or more skip frames, in accordance with some embodiments.

FIG. 7 is a block diagram of a client device configured to decode a packetized game stream with one or more skip packets within a cloud-based gaming system, in accordance with some embodiments.

FIG. 8 is a flow diagram of an example method for decoding a packetized game stream including one or more skip packets, in accordance with some embodiments.

### DETAILED DESCRIPTION

Techniques and systems described herein address the demands of providing a video stream of a legacy gaming application from one or more servers to a client system at a high frame rate. Such legacy gaming applications are configured to be executed by earlier or outdated operating systems, hardware, or both at frame rates lower than the frame rates of the video streams provided by the servers to the client system. To support these legacy gaming systems for cloud-based gaming, a server of a cloud-based gaming system first renders a set of game frames for a legacy gaming application at a specified frame rate associated with the legacy gaming application. An encoder of the server then determines if the specified frame rate of the set of game frames (e.g., the frame at which the game frames were rendered) is lower than a predetermined target frame rate associated with the encoder. Such a predetermined target frame rate, for example, indicates the frame rate of a resulting game stream (e.g., video stream) provided to a client system.

In response to the specified frame rate of the set of game frames not being lower than the predetermined target frame rate associated with the encoder, the encoder encodes each game frame of the set of game frames to produce a game stream. The server then packetizes the game stream and transmits the packetized game stream to the client system of the client gaming session. In response to the specified frame rate being lower than the predetermined target frame rate associated with the encoder, the encoder encodes each game frame of the set of game frames to produce a set of encoded game frames. Additionally, in response to the frame rate of the set of game frames being lower than the predetermined target frame rate associated with the encoder, the encoder generates one or more skip frames and inserts the skip frames between two or more encoded frames of the set of encoded game frames to generate a game stream. Each skip frame includes data indicating (for a decoder, e.g., at the client system) that one or more encoded game frames in the set of encoded game frames are to be repeated. For example, each skip frame includes data, referred to as “skip data”, indicating that the encoded game frame immediately preceding the skip frame in the game stream is to be repeated, wherein the skip data (e.g., a flag) is smaller (e.g., includes less data) than the frame data for the frame being skipped. By inserting the skip frames in this way, the resulting game stream has a frame rate equal to the predetermined target frame rate associated with the encoder. Additionally, because each skip frame includes the skip data rather than an entire encoded frame, the size of the resulting game stream is decreased, which in turn reduces the bandwidth needed to transmit the game stream.

After the game stream including the encoded game frames and skip frames is generated, the server packetizes the game stream to produce a packetized game stream including a plurality of frame packets (e.g., packets indicating an encoded frame) and a plurality of skip packets (e.g., packets indicating a skip frame). The server then transmits each packet of the packetized game stream to the client system. In response to receiving a packetized game stream, the client system is configured to decode and display one or more game frames indicated in the packetized game stream based on the frame packets and skip packets. For example, in response to receiving a frame packet, the client system decodes the encoded game frame indicated in the frame packet and displays the decoded game frame on a display. Additionally, in response to receiving a skip frame packet, the client system maintains or repeats the decoded game frame currently displayed on the display. In this way, the client system displays the decoded frames at the predetermined target frame rate associated with the encoder rather than the frame rate of the legacy gaming application. As such, the decoded frames are displayed at a higher frame rate, helping to improve interactivity with the gaming application at the client system.

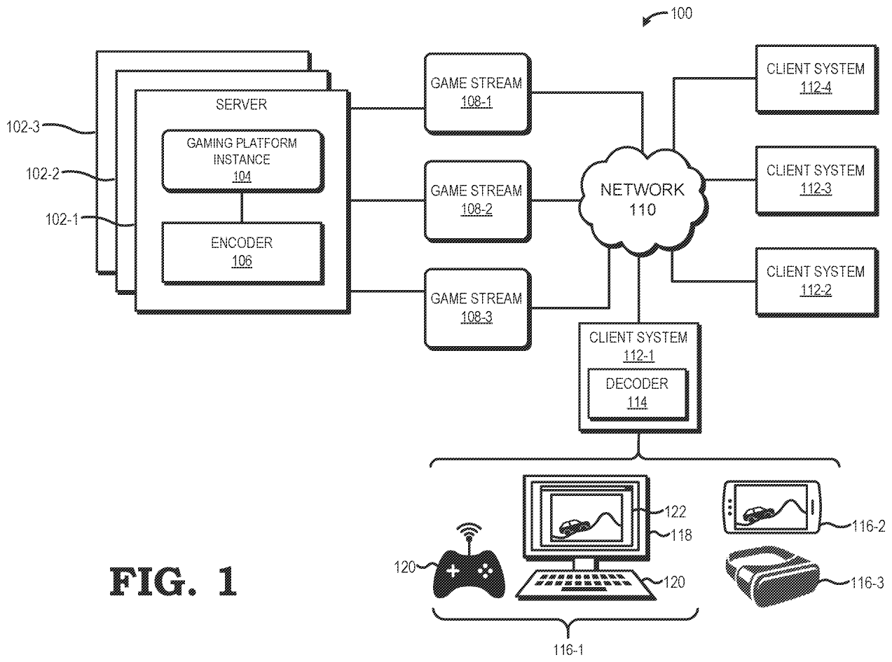

FIG. 1 illustrates a cloud-based gaming system 100 for single-player or multiplayer (including massively multiplayer) gaming, according to some embodiments. Cloud-based gaming system 100 includes one or more servers 102, with each server 102 communicatively coupled to one or more client systems 112 by at least one network 110. Network 110 is configured to allow for the transmission and reception of data between any of servers 102 and client systems 112 and includes, for example, wired and wireless networks, such as Ethernet, the Internet, Wi-Fi, or any combination thereof. In embodiments, each server 102 is communicatively interconnected via a high-bandwidth, low-latency inter-server messaging bus. Servers 102 are typically distributed in one or more data centers over a geographical area so as to reduce transmission latency through physical proximity. Though in the illustrated embodiment, three servers 102-1, 102-2, and 102-3 are presented supporting four client systems 112-1, 112-2, 112-3, and 112-4, in other embodiments, any number of servers may be implemented supporting any number of client devices. It will be appreciated that in a typical real-world implementation, the quantity of servers 102 and quantity of client systems 112 typically will be considerably higher than presented in the example of FIG. 1.

In the depicted embodiment, each server 102 includes a computing device such as, for example, a cloud server, virtual server, or any combination thereof configured to support one or more client gaming sessions executed on one or more client systems 112. A “client gaming session”, as used herein, includes a gaming application being played, partially simulated, or fully simulated on client system 112. Each server 102 is configured to support this client gaming session by executing a corresponding game platform instance 104 that facilitates the execution of at least a portion of the gaming application being played, partially simulated, or fully simulated on the client system 112. Such facilitation can include performing one or more operations related to the gaming application, such as, for example, rendering one or more frames related to the gaming application, performing calculations related to the gaming application (e.g., lighting calculations, artificial intelligence calculation, physics calculations, shading calculations, input calculations, and the like), providing access to files, or any combination thereof, to name a few. The game platform instance 104 provides various software and hardware resources to achieve such facilitation, such as communication/network management, resource management, media rendering encoding, and the like. In this way, game platform instance 104 simulates the execution of one or more operations of the gaming application for a corresponding player as though that gaming application was being played on a local gaming device, such as a personal computer (“PC”), game console, smartphone, tablet computer, automotive entertainment system, and the like.

Each client system 112 represents the hardware and software resources utilized to receive player input through manipulation of one or more input/output devices for at least one player, as well as to present the video and audio content representing the visual and auditory content, respectively, of the gameplay for the at least one player. Examples of a client system 112 include one or more desktop computers, notebook computers, tablet computers, virtual-reality systems, augmented reality systems, a compute-enabled cellular phone (i.e., a “smartphone”), a compute-enabled television (i.e., a “smart TV”), or any combination thereof, to name a few. As illustrated with reference to client system 112-1, each client system 112 includes one or more client devices 116. In the illustrated embodiment, client system 112-1 comprises a first client device 116-1, which is communicatively coupled to, or otherwise associated with, display 118, at least one input device 120 (e.g., a gamepad, joystick, keyboard, mouse, touchscreen), one or more network interfaces configured to couple to the network connecting the client system 112 to a corresponding server 102, one or more processors, memory, storage, speakers, and other computing resources to render, process, and display scenes of a virtual environment. As illustrated with reference to client system 112-1, each client system 112 can include a decoder 114 configured to decode one or more frames related to a virtual environment. Decoder 114 can include hardware and software configured to decode one or more encoding streams (e.g., game streams 108) received from servers 102 so as to produce a decoded set of frames or decoded stream. Each decoder 114 is configured to decode any encoded frame encoded by any method or process disclosed herein. In embodiments, client system 112-1 further comprises a smartphone client device 116-2, and a wearable virtual reality client device 116-3, each of which may operate as an integrated mobile computing device having input facilities, output facilities, display facilities, and communication facilities analogous to those noted above with respect to client system 112-1. In certain embodiments, client systems 112-1, 112-2, and 112-3 may include one or more facilities such as accelerometers, Global Positioning System (GPS) devices, and the like that are used to acquire motion data representing a movement of the client device, as well as a rate or acceleration of such movement.

While certain aspects described herein will be discussed with specific reference to cloud gaming scenarios, it will be appreciated that in certain embodiments the described techniques may be utilized in various non-gaming scenarios, such as if one or more of servers 102 and client systems 112 operate to render, process, and display other types of informational, educational, recreational and/or artistic content. It will therefore be further appreciated that while techniques are discussed herein with respect to the rendering of content that may utilize particular examples relevant to cloud gaming and gaming content, such discussions and techniques may be applied to such non-gaming scenarios. Examples provided herein may refer to scenarios involving the rendering, processing, and display of gaming content due to particular bandwidth and network latency issues relevant to such content and should not be construed to indicate that the techniques described are limited to those scenarios.

During operation, each server 102 executes a gaming platform instance 104 for one or more client gaming sessions. Executing game platform instance 104 includes rendering a set of game frames that includes one or more game frames associated with the gaming application being executed on one or more respective client systems 112. Each rendered game frame depicts at least a portion of a virtual environment used in the gaming application executed on the client system 112. For example, each rendered game frame can depict at least a portion of a virtual environment displayed on a display 118 of a client system 112 during the client gaming session. In embodiments, gaming platform instance 104 is configured to support gaming applications each having respective frame rate requirements. Such frame rate requirements include, for example, a minimum frame rate for rendering frames of the gaming application, a maximum frame rate for rendering frames of the gaming application, a fixed frame rate for rendering frames of the gaming application, an average frame rate for rendering frames of the gaming application, or any combination thereof. As an example, game platform instance 104 is configured to render game frames for a legacy gaming application (e.g., a gaming application configured to be executed by an earlier or outdated operating system, hardware, or both) at a fixed frame rate of 30 frames per second (FPS).

Each server 102 is further configured to encode each rendered game frame via encoder 106 so as to generate a respective encoded set of frames (also referred to herein as “game stream” 108). Each server 102 is configured to encode a game stream 108 through, for example, compression, reorganization, and manipulation of each frame rendered by gaming platform instance 104. In embodiments, each encoder 106 of a server 102 implements one or more codecs so as to encode one or more rendered frames according to the one or more codecs. Such codecs can include H.264, H.265, VP9, AV1, or any combination thereof, to name a few. According to embodiments, each server 102 is configured to encode each game frame rendered by gaming platform instance 104 via an encoder 106 at a predetermined target frame rate (e.g., a predetermined target number of frames per second). That is to say, an encoder 106 is configured to encode the game frames rendered by gaming platform instance 104 such that the resulting game stream 108 has a predetermined target frame rate. A predetermined target frame rate includes, for example, a predetermined fixed frame rate, a predetermined average frame rate, a predetermined minimum frame rate, a predetermined maximum frame rate, or any combination thereof. For example, a server 102 includes a respective encoder 106 configured to encode each game frame rendered by gaming platform instance 104 at a predetermined target frame rate (e.g., fixed frame rate) of 60 FPS.

The game streams 108 that result from encoding the game frames each correspond to a gaming application being executed on one or more client systems 112 and is provided to these corresponding client systems 112 via network 110. In embodiments, to provide a gaming stream 108 to a corresponding client system 112, each server 102 is configured to packetize the gaming stream 108 before it is transmitted to the client system. To packetize a gaming stream 108, a server 102 is configured to create a data structure (e.g., packet) for each encoded frame of the gaming stream 108 that includes, for example, a header (e.g., Real-time Transport Protocol (RTP) header, Real-time Streaming Protocol (RTSP) header, Session Initiation Protocol (SIP) header), a payload, and a trailer. A header of a packet, for example, includes data indicating the corresponding client system 112 supporting the client gaming session associated with the game stream 108, the number of packets in a packetized game stream 108, a next packet in a packetized game stream 108, or any combination thereof. The payload of a packet, for example, includes data representing an encoded game frame (e.g., a compressed game frame) encoded by an encoder 106. The trailer of a packet, for example, includes data representing the end of the packet, an error correction code, or both. According to embodiments, each server 102 is configured to transmit each packet of a packetized game stream 108 to a corresponding client system 112 based on a predetermined packet transmission rate. The predetermined packet transmission rate includes, for example, data indicating a predetermined rate to transmit the packets of a packetized game stream 108 (e.g., indicating a number of bits to transmit per second). For example, a predetermined packet transmission rate includes data indicating a rate to transmit a packet of a packetized game stream 108 every 16 milliseconds.

Corresponding client systems 112 are each configured to decode a received packetized game stream 108 via a decoder 114 and display the resulting decoded set of frames 122 on, for example, a display 118. Each client system 112 is configured to decode a respective game stream 108 by decompression, reorganization, and manipulation of the frames within the encoded stream according to one or more various video codecs including lossless and lossy codecs. According to embodiments, each client system 112 includes a decoder that implements one or more codecs so as to decode a received game stream 108 according to the one or more codecs. Such codecs can include H.264, H.265, VP9, AV1, or any combination thereof, to name a few. Though three game streams 108-1, 108-2, 108-3 are depicted in the illustrated embodiment, in other embodiments, servers 102 can generate any number of game streams 108 each corresponding to one or more client gaming sessions.

In embodiments, a server 102 is configured to render frames for a gaming application (e.g., legacy gaming application) at a frame rate lower than the predetermined target frame rate of one or more encoders 106. To support such gaming applications, server 102 is configured to encode the frames of the gaming application based on one or more codecs via an encoder 106 to produce a set of encoded game frames. Additionally, while the encoder 106 is encoding the game frames of the gaming application, server 102 is configured to generate and insert one or more skip frames into a game stream 108 (e.g., set of encoded game frames) resulting from encoding the game frames of the application. A skip frame includes, for example, data indicating that a preceding game frame in a game stream is repeated (e.g., the display of the preceding game frame is maintained for the duration of one or more frame lengths). That is to say, a skip frame includes data (e.g., a flag) indicating that a previously encoded frame is to be repeated in the game stream 108. As such, a skip frame is smaller (e.g., includes less data) than an encoded game frame because the skip frame includes data indicating that a preceding game frame in a game stream is repeated (e.g., a flag) rather than including data representing the entirety of an encoded frame. For example, in embodiments, a skip frame includes two or more times less data (e.g., in bits) than an encoded game frame. According to embodiments, server 102 is configured to insert skip frames into game stream 108 based on the difference between the frame requirements associated with the gaming application and the predetermined target frame rate of the encoder 106. For example, server 102 is configured to determine a number of skip frames to insert, locations for skip frames in a game stream 108, or both based on the difference between the frame requirements associated with the gaming application and the predetermined target frame rate of the encoder 106. In this way, the server 102 is able to encode the game stream 108 according to the predetermined target frame rate while still rendering the game frames of the gaming application according to the frame rate requirements of the legacy gaming application. As such, the server 102 is configured to support a game stream 108 of a legacy gaming application at a frame rate indicated in the predetermined target frame rate. Additionally, because every skip frame includes data indicating that a previously encoded frame is to be repeated rather than an entire encoded frame, the size (e.g., in bits) of a resulting game stream 108 is reduced (e.g., compared to an upscaled game stream), helping reduce the bandwidth needed to transmit the game stream 108 to a client system 112.

As an example, a server 102 is configured to support a legacy gaming application having a frame rate requirement indicating, for example, a fixed frame rate of 30 FPS. To support the legacy gaming application, a game platform instance 104 of the server 102 renders the frames of the legacy gaming application based on the frame rate requirements associated with the legacy gaming application, for example, a fixed frame rate of 30 frames per second (FPS). The server 102 then, via an encoder 106, encodes the rendered game frames according to a predetermined target frame rate indicating a fixed frame rate of Based on the difference between the frame rate requirements associated with the legacy gaming application (e.g., 30 FPS) and the predetermined target frame rate of the encoder 106 (e.g., 60 FPS) the server 102 determines a number of skip frames to insert into a resulting game stream 108 and the locations of the skip frames within the game stream 108. For example, the server 102 inserts a skip frame indicating a preceding encoded frame is to be repeated after every encoded frame in the game stream 108. In this way, the server 102 provides a game stream 108 at 60 FPS of a legacy gaming application rendered at 30 FPS.

After encoding a game stream 108 including one or more skip frames, a server 102 is configured to packetize the encoded frames and skip frames of the game stream 108 into a plurality of packets. For example, a server 102 is configured to packetize each encoded frame of a game stream 108 into a respective packet and each skip frame into a respective packet. In response to packetizing such a game stream, the server 102 transmits each packet of the packetized game stream 108 according to the predetermined packet transmission rate to a respective client system 112. For example, server 102 transmits a packet of the packetized game stream 108 according to a periodic time period based on the predetermined packet transmission rate. As an example, server 102 transmits a packet of a packetized game stream 108 every 16 milliseconds to a respective client system 112. Because every skip frame includes data indicating that a previously encoded frame is to be repeated rather than including data representing an entire encoded frame, the size of a packet of a skip frame is smaller (e.g., in bits) than a packet of an encoded frame (e.g., a packet that includes data representing the entire encoded frame). As an example, the payload of a packetized skip frame including data (e.g., a flag) indicating a previously encoded frame is to be repeated is smaller (e.g., in bits) than the payload of a packetized encoded frame because the data (e.g., a flag) indicating a previously encoded frame is to be repeated is smaller (e.g., in bits) than an encoded frame. In this way, the time needed to transmit the packet of a skip frame to a client system is lower than that of a packet of an encoded frame. As such, during the time period a packet of a skip frame is transmitted, only a portion of the time period is devoted to transmitting the packet of the skip frame, allowing the server 102 to empty at least a portion of one or more queues of one or more network buffers during the remainder of the time period and help mitigate network congestion.

In response to receiving a game stream 108 (e.g., a packetized game stream 108) including one or more skip frames, a client system 112 is configured to decode the received game stream 108 via a decoder 114 based on the number and location of the skip frames in the game stream. For example, in response to receiving a packet of a packetized game stream 108, a client system 112 is configured to determine whether or not the received packet indicates an encoded frame (e.g., a game frame encoded by an encoder 106) or a skip frame. In response to the packet indicating an encoded frame, a decoder 114 of the client system 112 decodes the encoded game frame and displays the decoded game frame on a display 118. In response to the packet indicating a skip frame, the client system 112, for example, repeats (e.g., maintains) the most recently decoded game frame on display 118. In this way, the client system 112 displayed the decoded gaming stream 108 at a frame rate based on the predetermined target frame rate of the encoder.

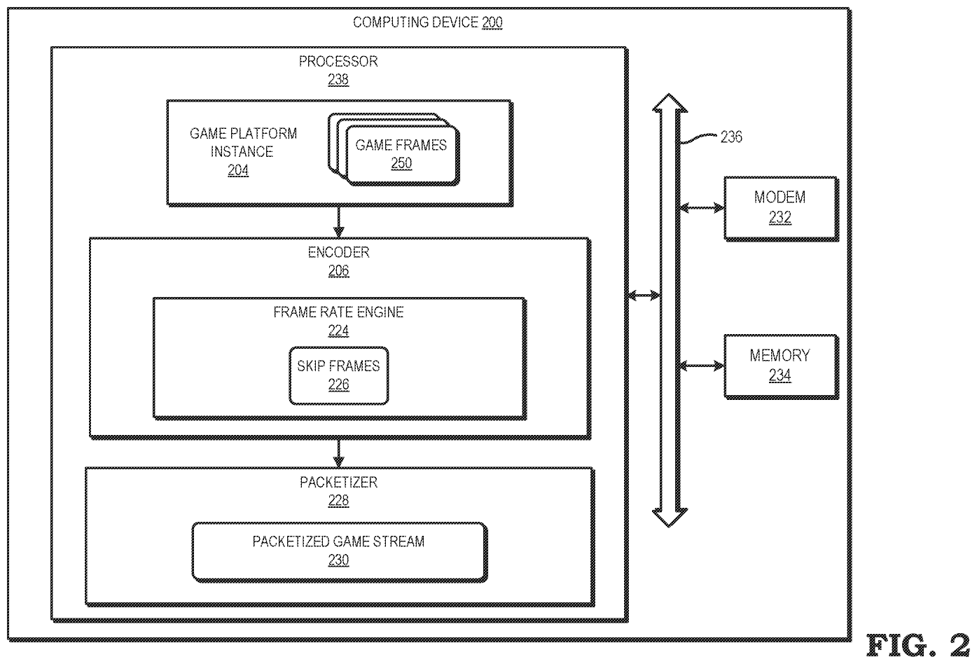

Referring now to FIG. 2, a computing device 200 configured to encode and stream game streams including one or more skip frames within a cloud-based gaming system is illustrated. In embodiments, computing device 200 implements aspects of cloud-based gaming system 100 as described in FIG. 1. For example, computing device 200 may be similar or the same as server 102 described in FIG. 1. Computing device 200 includes one or more software and hardware components for bi-directional communications including components for encoding a set of game frames 250 such as to produce a game stream 108, components for packetizing a game stream 108 into a packetized game stream 230, or both. In some embodiments, computing device 200 is part of an electronic device that supports encoding of a set game frames 250, including, for example, a desktop computer, a notebook computer, a tablet, a server, or a game console, to name a few. In embodiments, computing device 200 includes processor 238, modem 232, and memory 234. Memory 234 includes an electronic storage device, such as for example, a solid-state drive, a hard disk drive, random access memory (“RAM”), read-only memory (“ROM”), electronically erasable programmable ROM (“EEPROM”), optical storage device, or any combination thereof. Memory 234 includes instructions and data related to the operation of game platform instance 204, encoders 206, frame rate engine 224, and packetizer 228 such as, for example, codecs, reference frames, gaming engines, gaming applications, constants, and the like. Modem 232 is configured to be communicatively coupled to one or more client systems 112 via a network 110 and further configured to transmit a game stream 108, packetized game stream 230, or both to the one or more client systems 112. According to embodiments, processor 238, modem 232, and memory 234 are internally in electronic communication via one or more interfaces (e.g., a bus 236).

According to embodiments, processor 238 includes one or more control processing units (“CPUs”), microprocessors, field-programmable gate arrays (“FPGAs”), graphics processing units (“GPUs”), application specific integrated circuits (ASICs), or any combination thereof and is configured to render and encode game frames for use in a client gaming session on cloud-based gaming system 100. Processor 238 operates to execute a game platform instance 204, the same or similar as game platform instance 104, associated with a current client gaming session and configured to support a gaming application executed on one or more client systems 112. Game platform instance 204 includes graphics hardware and software (not shown for clarity) to render a set of game frames 250 associated with an environment of the gaming application executed on the one or more client devices. Such graphics hardware and software include, for example, graphics cores, processing cores, pixel shaders, video random access memory (“VRAM”), GPUs, physics engines, lighting engines, tessellation engines, and the like. Each rendered game frame of the set of game frames 250 represents at least a portion of a virtual environment associated with the gaming application executed on the client device. For example, if the gaming application is a racing game, each game frame of the set of game frames 250 represents at least a portion of a racetrack, car, or surrounding area.

In embodiments, game platform instance 204 is configured to render game frames 250 based on one or more frame rate requirements associated with the gaming application running on game platform instance 204. A frame rate requirement includes, for example, a minimum frame rate for rendering frames of the gaming application, a maximum frame rate for rendering frames of the gaming application, a fixed frame rate for rendering frames of the gaming application, an average frame rate for rendering frames of the gaming application, or any combination thereof. As an example, game platform instance 204 is configured to render game frames for a legacy gaming application (e.g., a gaming application configured to be executed by an earlier or outdated operating system, hardware, or both) at a fixed frame rate (e.g., 30 FPS) indicated in one or more frame rate requirements associated with the legacy gaming application.

Each rendered game frame of the set of game frames 250 is provided to encoder 206 for encoding into a game stream 108. Encoder 206 includes one or more software and/or hardware encoders configured to encode game stream 108 according to, for example, interframe and intraframe techniques. To reduce the bandwidth needed to transmit a game stream 108 between computing device 200 and one or more client systems 112, encoder 206 encodes one or more game frames of a set of game frames 250 by compressing the game frames. Compressing a game frame includes comparing the game frame to one or more reference frames stored in, for example, memory 234 and encoding one or more of the differences between the game frame and the one or more reference frames into an encoded game frame. According to embodiments, encoder 206 is configured to encode each game frame of set of game frames 250 at a predetermined target frame rate (e.g., a predetermined target number of frames per second). That is to say, encoder 206 encodes the game frames of the set of game frames 250 such that the resulting game stream 108 has a predetermined target frame rate. A predetermined target frame rate includes, for example, a predetermined fixed frame rate, a predetermined average frame rate, a predetermined minimum frame rate, a predetermined maximum frame rate, or any combination thereof. As an example, encoder 206 is configured to encode each game frame rendered by gaming platform instance 104 at a predetermined target frame rate (e.g., fixed frame rate) of 60 FPS.

To help support encoding a set of game frames 250 rendered at a frame rate lower than the predetermined target frame rate of encoder 206 (e.g., a set of game frames 250 from a legacy gaming application), encoder 206 includes frame rate engine 224 which includes hardware-based circuitry, software-based circuitry, or both configured to generate one or more skip frames 226, insert one or more skip frames 226 into a game stream 108, or both. To this end, frame rate engine 224 is first configured to determine whether there is a difference between the frame requirements associated with the gaming application used to render the set of game frame 250 and the predetermined target frame rate of encoder 206, a difference between the frame rate (e.g., average frame rate, fixed frame rate) at which the set of game frames 250 is rendered and the predetermined target frame rate of encoder 206, or both. In response to the frame requirements associated with the gaming application used to render the set of game frame 250, the frame rate at which the set of game frames 250 is rendered, or both being lower than the predetermined target frame rate of encoder 206, frame rate engine 224 is configured to generate one or more skip frames 226. Each skip frame 226 includes, for example, data (e.g., a flag) indicating that a previously encoded frame is to be repeated in the game stream 108. In embodiments, frame rate engine 224 is configured to generate each skip frame based on one or more codecs used by encoder 206 to encode the set of game frame 250. For example, frame rate engine 224 is configured to determine a type of flag, a value of a flag, a location of a flag, or any combination thereof for a skip frame 226 based on the codec (e.g., H.264, H.265, VP9, AV1) used by encoder 206 to encode the set of game frames 250. Because a skip frame 226 includes data indicating a previously encoded frame is to be repeated rather than the data of an entire encoded frame, the size (e.g., in bits) of a skip frame 226 is smaller than the size of an encoded frame. For example, in embodiments, a skip frame 226 includes two or more orders of magnitude less data (e.g., in bites) than an entire encoded frame.

According to embodiments, frame rate engine 224 is configured to generate a number of skip frames 226 based on, for example, a difference between the frame requirements associated with the gaming application used to render the set of game frame 250 and the predetermined target frame rate of encoder 206, a difference between the frame rate at which the set of game frames 250 is rendered and the predetermined target frame rate of encoder 206, or both. For example, frame rate engine 224 is configured to generate a number of skip frames 226 such that a game stream 108 including encoded game frames of a set of game frames 250 and the skip frames 226 has a frame rate equal to the predetermined target frame rate of encoder 206. As an example, in response to a set of game frames 250 being rendered at 30 FPS and a predetermined target frame rate of encoder 206 indicating 60 FPS, frame rate engine 224 is configured to generate a number of skip frames 226 such that a game stream 108 including encoded game frames from the set of game frames 250 and the skip frames 226 is equal to 60 FPS (e.g., the predetermined target frame rate of encoder 206). In embodiments, frame rate engine 224 is configured to insert a skip frame 226 between two or more encoded frames of a game stream 108 based on a difference between the frame requirements associated with the gaming application used to render the set of game frame 250 and the predetermined target frame rate of encoder 206, a difference between the frame rate at which the set of game frames 250 is rendered and the predetermined target frame rate of encoder 206, or both. That is to say, frame rate engine 224 is configured to insert skip frames 226 at one or more locations within a game stream 108 based on a difference between the frame requirements associated with the gaming application used to render the set of game frame 250 and the predetermined target frame rate of encoder 206, a difference between the frame rate at which the set of game frames 250 is rendered and the predetermined target frame rate of encoder 206, or both. For example, in response to a set of game frames 250 being rendered at 30 FPS and a predetermined target frame rate of encoder 206 indicating 60 FPS, frame rate engine 224 is configured to insert a skip frame 226 after every encoded game frame in a game stream 108. In this way, the encoded game stream 108 including the encoded game frames and the skip frames 224 has a frame rate equal to the predetermined target frame rate of encoder 206 even when the set of game frames 250 is rendered at a lower frame rate.

After inserting one or more skip frames 226 into a game stream 108, the game stream 108 is provided to packetizer 228 to packetize the game stream 108 to produce a packetized game stream 230. Packetizer 228 includes hardware-based circuitry, software-base circuitry, or both configured to packetize a game stream 108 by, for example, generating a packet for each encoded frame and skip frame 226 in the game stream 108. Each packet generated by packetizer 228 includes, for example, a header (e.g., RTP header, RTSP header, SIP header), a payload, and a trailer. A header of a packet, for example, includes data indicating the corresponding client system 112 supporting the client gaming session associated with the game stream 108, the number of packets in a packetized game stream 230, a next packet in a packetized game stream 230, or any combination thereof. The payload of a packet, for example, includes data representing an encoded game frame (e.g., a compressed game frame) of a game stream 108 or data representing a skip frame 226 of a game stream 108. The trailer of a packet, for example, includes data representing the end of the packet, an error correction code, or both. After generating packets for each encoded game frame and skip frame 226 of a game stream 108 to produce a packetized game stream 230, packetizer 228 is configured to transmit each packet of a packetized game stream 230 to a corresponding client system 112 based on a predetermined packet transmission rate. The predetermined packet transmission rate includes, for example, data indicating a predetermined rate to transmit the packets of a packetized game stream 230 (e.g., indicating a number of bits to transmit per second). For example, packetizer 228 transmits each packet of the packetized game stream 230 according to a periodic time period based on the predetermined packet transmission rate. As an example, packetizer 228 transmits each packet of a packetized game stream 230 every 16 milliseconds to a respective client system 112. As every skip frame 226 includes data indicating that a previously encoded frame is to be repeated rather than including the data for an entire encoded frame, the size (e.g., in bits) of a packet of a skip frame 226 is smaller (e.g., in bits) than a packet of an encoded frame. That is to say, the payload of a packet of a skip frame 226 is smaller than the payload of an encoded frame because each skip frame 226 includes data (e.g., a flag) indicating a previously encoded frame is to be repeated rather than including the entirety of an encoded frame as a packet of an encoded frame does. For example, according to some embodiments, a packet of skip frame 226 includes two or more times less data (e.g., in bits) than the entirety of an encoded frame. Due to the size of a packet of a skip frame 226 being smaller than a packet of an encoded frame, during the time period a packet of a skip frame 226 is transmitted, only a portion of the time period is devoted to transmitting the packet of the skip frame 226 which allows computing device 200 to empty at least a portion of one or more queues of one or more network buffers during the remainder of the time period and helps alleviate network congestion.

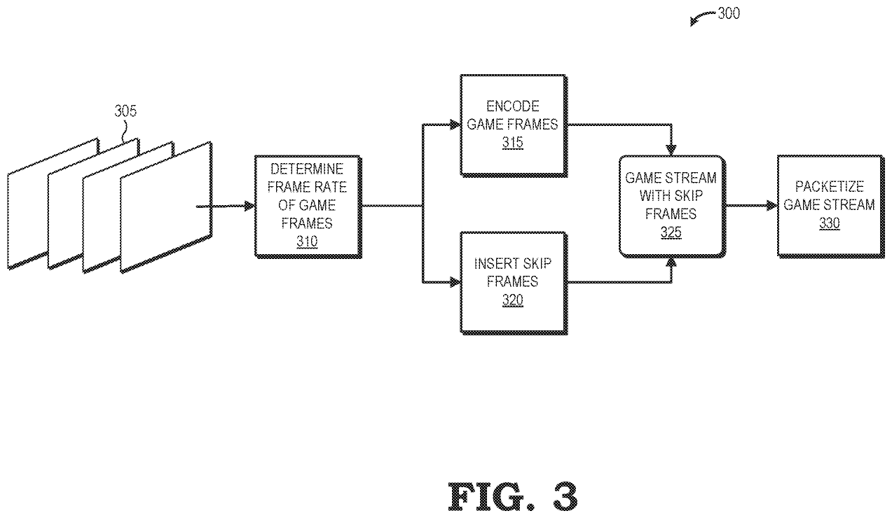

Referring now to FIG. 3, an example operation 300 for encoding a game stream with one or more skip frames is presented. In embodiments, operation 300 is configured to encode a set of game frames 305, similar to or the same as set of game frames 250, generated by a game platform instance, similar to or the same as game platform instance 204. The game platform instance is configured to render the set of game frames 305 based on one or more frame rate requirements associated with a gaming application running on the game platform instance. Such frame rate requirements include, for example, a minimum frame rate for rendering frames of the gaming application, a maximum frame rate for rendering frames of the gaming application, a fixed frame rate for rendering frames of the gaming application, an average frame rate for rendering frames of the gaming application, or any combination thereof. For example, the game platform instance is configured to generate the set of game frames 305 at a fixed frame rate (e.g., 30 FPS) indicated in a frame rate requirement associated with the gaming application running on the game platform instance.

According to embodiments, operation 300 includes a determine frame rate operation 310 which includes a frame rate engine, similar to or the same as frame rate engine 224, determining the frame rate of the set of game frames 305. That is to say, the frame rate engine determines the frame rate at which the set of game frames 305 was rendered. In embodiments, the frame rate engine is configured to determine the frame rate of the set of game frames 305 based on a frame rate requirement associated with the gaming application (e.g., the gaming application used to generate the set of game frames 305), a measurement of the set of game frames 305, or both. In embodiments, operation 300 further includes an encode game frames operation 315 which includes an encoder, similar to or the same as encoder 106, 206, encoding each game frame of the set of game frames 305 according to one or more codecs to generate a game stream 108. According to embodiments, encoder 206 is configured to generate such a game stream 108 according to a predetermined target frame rate. A predetermined target frame rate includes, for example, a predetermined fixed frame rate, a predetermined average frame rate, a predetermined minimum frame rate, a predetermined maximum frame rate, or any combination thereof. For example, the encode is configured to encode each game frame of the set of game frames 305 at a predetermined target frame rate (e.g., fixed frame rate) of 60 FPS.

To facilitate the encoder encoding a set of game frames 305 rendered at a frame rate lower than the predetermined target frame rate of the encoder, operation 300 includes insert skip frame operation 320. The insert skip frame operation 320 includes the frame rate engine first determining if the frame rate of the set of game frames 305 (e.g., the frame rate at which the set of game frames 305 was rendered) is lower than the predetermined target frame rate of the encoder. In response to the frame rate of the set of game frames 305 being lower than the predetermined target frame rate of the encoder, the frame rate engine is configured to generate one or more skip frames, similar to or the same as skip frames 226, and insert the skip frames between two or more encoded frames generated by the encoder (e.g., one or more frames of the set of game frames 305 as encoded by the encoder). Each skip frame includes, for example, data indicating that a preceding game frame in a game stream is repeated (e.g., maintained). That is to say, a skip frame includes data (e.g., a flag) indicating that a previously encoded frame is to be repeated in a game stream 108. In embodiments, the frame rate engine is configured to generate each skip frame based on one or more codecs used by the encoder to encode the set of game frame 305. For example, the frame rate engine is configured to determine a type of flag, a value of a flag, a location of a flag, or any combination thereof for a skip frame based on the codec (e.g., H.264, H.265, VP9, AV1) used by the encoder to encode the set of game frames 305. According to embodiments, the frame rate engine is configured to determine a number of skip frames based on, for example, a difference between the frame requirements associated with the gaming application used to render the set of game frames 305 and the predetermined target frame rate the encoder, a difference between the frame rate of the set of game frames 305, or both. For example, the frame rate engine is configured to generate a number of skip frames such that the game stream (e.g., game stream with skip frames 325) including encoded game frames of the set of game frames 305 and the skip frames has a frame rate equal to the predetermined target frame rate of the encoder. As an example, in response to the set of game frames 305 having a frame rate of 30 FPS and a predetermined target frame rate of the encoder indicating 60 FPS, the frame rate engine is configured to generate a number of skip frames such that a game stream (e.g., game stream with skip frames 325) including encoded game frames from the set of game frames 305 and the skip frames is equal to 60 FPS (e.g., the predetermined target frame rate of the encoder).

According to embodiments, the frame rate engine is configured to insert one or more skip frames between two or more encoded frames of the set of game frames 305 to generate game stream with skip frames 325. The frame rate engine is configured to insert one or more skip frames between two or more encoded frames (e.g., from the set of game frames 305) encoded by the encoder based on a difference between the frame requirements associated with the gaming application used to render the set of game frames 305 and the predetermined target frame rate of the encoder, a difference between the frame rate of the set of game frames 305 and the predetermined target frame rate the encoder, or both. For example, in response to the set of game frames 305 having a frame rate of 30 FPS and a predetermined target frame rate of the encoder indicating 60 FPS (e.g., a fixed frame rate of 60 FPS), the frame rate engine is configured to insert a skip frame after every encoded game frame. In this way, the frame rate engine generates a game stream with skip frames 325 having a frame rate equal to the predetermined target frame rate of the encoder even when the set of game frames 305 has a lower frame rate.

After generating the game stream with skip frames 325, the encoder provides the game stream with skip frames 325 to a packetizer, similar to or the same as packetizer 228. In embodiments, the operation 300 includes a packetize game stream operation 330 which includes the packetizer packetizing the game stream with skip frames 325 by, for example, generating a packet for each encoded frame and skip frame in the game stream with skip frames 325. Each packet generated by the packetizer includes, for example, a header (e.g., RTP header, RTSP header, SIP header), a payload, and a trailer. A header of a packet, for example, includes data indicating the corresponding client system 112 supporting the client gaming session associated with the game stream with skip frames 325, the number of packets in a packetized game stream, a next packet in a packetized game stream, or any combination thereof. The payload of a packet, for example, includes data representing an encoded game frame (e.g., a compressed game frame) of the game stream with skip frames 325 or data representing a skip frame of the game stream with skip frames 325. The trailer of a packet, for example, includes data representing the end of the packet, an error correction code, or both. After generating packets for each encoded game frame and skip frame of the game stream with skip frames 325 to, for example, generate a packetized game stream, the packetizer is configured to transmit each packet of the packetized game stream to a corresponding client system 112 based on a predetermined packet transmission rate. The predetermined packet transmission rate includes, for example, data indicating a predetermined rate to transmit the packets of a packetized game stream (e.g., indicating a number of bits to transmit per second). For example, the packetizer transmits each packet of the packetized game stream according to a periodic time period based on the predetermined packet transmission rate. Because the size (e.g., in bits) of a packet of a skip frame is smaller (e.g., in bits) than a packet of an encoded frame, during the time period a packet of a skip frame is transmitted, the packetizer only uses a portion of the time period to transmit the packet of the skip frame to a client system 112. As such, in embodiments, the packetizer spends the remaining portion of such a time period emptying at least a portion of one or more queues of one or more network buffers which helps to alleviate network congestion.

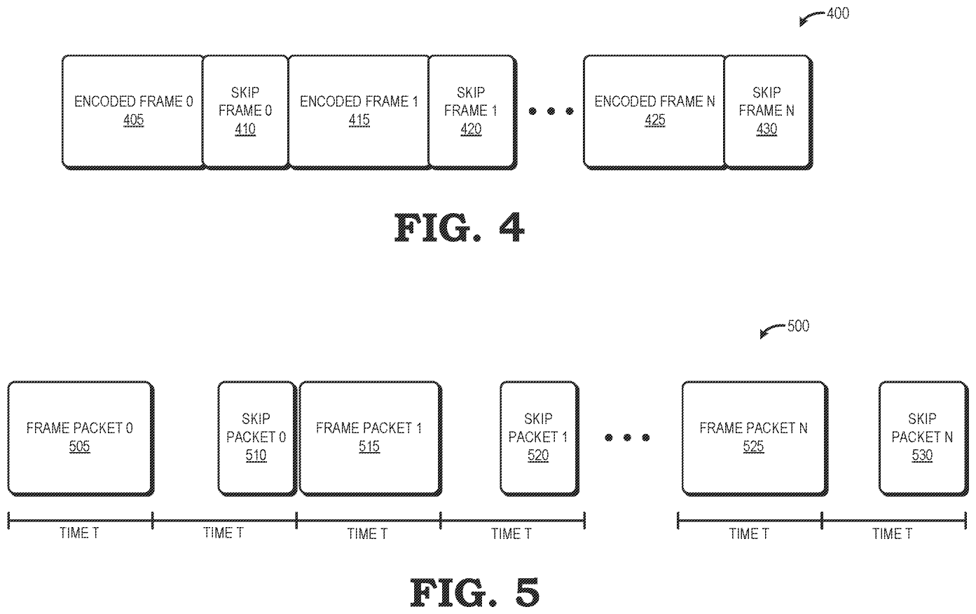

Referring now to FIG. 4, a diagram of an example game stream 400 with skip frames is presented. In embodiments, a frame rate engine, similar to or the same as frame rate engine 224, is configured to insert skip frames at one or more locations within a game stream 108 based on a difference between the frame requirements associated with the gaming application used to render the set of game frames (e.g., set of game frames 250, 305) and the predetermined target frame rate of an encoder (e.g., encoder 106, 206), a difference between the frame rate of a set of game frames and the predetermined target frame rate the encoder, or both. As an example, referring to the example embodiment illustrated in FIG. 4, in response to a set of game frames being rendered at a lower frame rate, for example of 30 FPS, and a predetermined target higher frame rate of an encoder, for example indicating 60 FPS, the frame rate engine is configured to insert a skip frame after every encoded game frame in the game stream 400. For example, the frame rate engine inserts skip frame 0 410 (e.g., including data indicating to repeat encoded frame 0 405) after encoded frame 0 405, skip frame 1 420 (e.g., including data indication to repeat encoded frame 1 415) after encoded frame 1 415, and skip frame N 430 (e.g., including data indicating to repeat encoded frame N 425) after encoded frame N 425. In this way, the game stream 400 has a frame rate equal to the predetermined target frame rate of the encoder (e.g., even when the set of game frames is rendered at a lower frame rate (e.g., 30 FPS). Though the example embodiment illustrated in FIG. 4 presents three skip frames (410, 420, 430) representing an N number of skip frames each inserted after a respective encoded frame (405, 415, 425), in other embodiments, any number of skip frames may be inserted between any number of encoded frames of the game stream 400. Because each skip frame 410, 420, 430 includes data indicating an encoded frame is to be repeated rather than including data indicating the entirety of an encoded frame as encoded frame 0 405, encoded frame 1 415, and encoded frame N 425 do, each skip frame 410, 420, 430 is smaller in size (e.g., contains less data) than the encoded frames 405, 415, 425. As an example, referring to the example embodiment illustrated in FIG. 4, skip frame 0 410 (e.g., including data indicating encoded frame 0 405 is to be repeated) is smaller (e.g., contains less data) than encoded frame 0 405 which includes data representing the entirety of an encoded frame. Such a difference in size is represented in the example embodiment illustrated in FIG. 4, for example, by skip frame 0 410 having a narrower width than encoded frame 0 405.

Referring now to FIG. 5, a timing diagram of an example packetized game stream 500 with skip frames is presented. In embodiments, a packetizer, similar to or the same as packetizer 228, is configured to packetize each encoded frame and skip frame of a game stream (e.g., game stream 108, game stream with skip frames 325) to generate packetized game stream 400. Referring to the example embodiment illustrated in FIG. 5, the packetizer packetizes a first encoded frame (e.g., encoded frame 0 405) to generate frame packet 0 505, a first skip frame (e.g., skip frame 0 410) to generate skip packet 0 510, a second encoded frame (e.g., encoded frame 1 415) to generate frame packet 1 515, a second skip frame (e.g., skip frame 1 420) to generate skip packet 1 520, an Nth encoded frame (e.g., encoded frame N 425) to generate frame packet N 525, and an Nth skip frame (e.g., skip frame N 430) to generate skip packet N to generate packetized game stream 500. Though the example embodiment illustrated in FIG. 5 presents packetized game stream 500 including three frame packets (505, 515, 525) representing an N number of frame packets and three skip packets (510, 520, 530) representing an N number of skip packets, in other embodiments packetized game stream 500 may include any number of frame packets and any number of skip packets. Because each skip packet 510, 520, 530 includes, for example, a payload including data indicating an encoded frame is to be repeated rather than a payload including data indicating the entirety of an encoded frame as frame packet 0 505, frame packet 1 515, and frame packet N 525 do, each skip packet 510, 520, 530 has a smaller payload and is thus smaller in size (e.g., contains two or more times less data) than the frame packets 505, 515, 525. As an example, referring to the example embodiment illustrated in FIG. 5, skip packet 0 510 (e.g., including a payload with data indicating an encoded frame is to be repeated) is smaller (e.g., contains less data) than frame packet 0 505 which includes a payload with data representing the entirety of an encoded frame. Such a difference in size is represented in the example embodiment illustrated in FIG. 5, for example, by skip packet 0 510 having a narrower width than frame packet 0 505. In some embodiments, for example, a width of a skip packet 510, 520, 530 is two more or orders of magnitude narrower than a frame packet 505, 515, 525 to reflect the difference in size.

According to embodiments, the packetizer then transmits each packet of the packetized game stream 500 to a respective client system 112 according to a periodic time period based on a predetermined packet transmission rate associated with the packetizer. As an example, the packetizer transmits each packet of packetized game stream 500 for a time period T. Referring to the example embodiment illustrated in FIG. 5, the packetizer is configured to transmit each of frame packet 0 505, skip packet 0 510, frame packet 1 515, skip packet 1 520, frame packet N 525, and skip packet N 530 for a time period T (e.g., 16 milliseconds). Because the size (e.g., in bits) of each skip packet is smaller than a frame packet, the packetizer only uses a portion of the time period T to transmit each skip packet. Referring to the example embodiment illustrated in FIG. 5, the packetizer only uses a portion of a respective time period T to transmit skip packet 0 510, skip packet 1 520, and skip packet N 530 and uses an entirety of a respective time period T to transmit frame packet 0 505, frame packet 1 515, and frame packet N 525. In this way, the packetizer is configured to empty at least a portion of one or more queues of one or more network buffers during the remainder of a time period T not used to transmit a skip packet. By emptying the network buffers in this way, the packetizer helps alleviate congestion on the network.

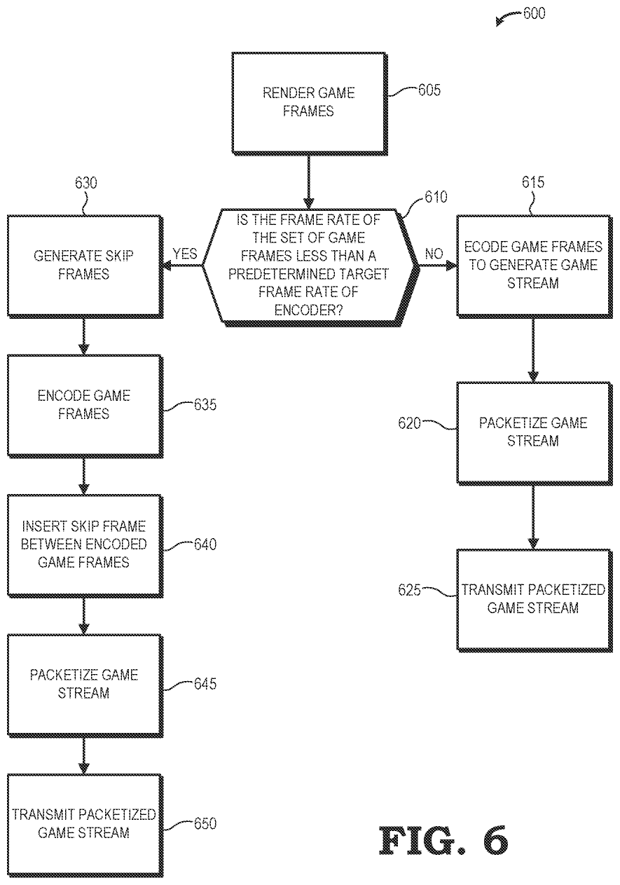

Referring now to FIG. 6, an example method 600 for generating a game stream with one or more skip frames is presented. At step 605 of the method 600, a game platform instance, similar to or the same as game platform instance 204, is configured to render a set of game frames, similar to or the same as set of game frames 250, 305, based on a gaming application running on the game platform instance and associated with a current client gaming session. In embodiments, the game platform instance is configured to render the set of game frames based on one or more frame rate requirements associated with the gaming application running on the game platform instance. Such frame rate requirements include, for example, a minimum frame rate for rendering frames of the gaming application, a maximum frame rate for rendering frames of the gaming application, a fixed frame rate for rendering frames of the gaming application, an average frame rate for rendering frames of the gaming application, or any combination thereof. For example, the game platform instance is configured to generate the set of game frames at a fixed frame rate (e.g., 30 FPS) indicated in a frame rate requirement associated with the gaming application running on the game platform instance.

At step 610, a frame rate engine, similar to or the same as frame rate engine 224, included in or otherwise communicatively coupled to an encoder, similar to or the same as encoder 106, 206, determines whether the frame rate of the set of game frames (e.g., the frame rate at which the set of game frames was rendered) is lower than a predetermined target frame rate associated with the encoder. Such a predetermined target frame rate includes, for example, a predetermined fixed frame rate, a predetermined average frame rate, a predetermined minimum frame rate, a predetermined maximum frame rate, or any combination thereof. In response to the the frame rate of the set of game frames (e.g., the frame rate at which the set of game frames was rendered) not being lower than a predetermined target frame rate associated with the encoder, the system moves on to step 615. At step 615, the encoder encodes each game frame of the set of game frames into a game stream 108 according to one or more codecs. For example, the encoder compresses each game frame of the set of game frames by encoding one or more of the differences between the game frame and one or more reference frames into an encoded game frame of a game stream. At step 620, a packetizer, similar to or the same as packetizer 228, packetizes each encoded game frame of the generated game stream to produce a packetized game stream. Each packet of a packetized game stream generated by the packetizer includes, for example, a header (e.g., RTP header, RTSP header, SIP header), a payload, and a trailer. A header of a packet, for example, includes data indicating the corresponding client system 112 supporting the client gaming session associated with the game stream 108, the number of packets in a packetized game stream, a next packet in a packetized game stream, or any combination thereof. The payload of a packet, for example, includes data representing the encoded game frame (e.g., a compressed game frame) of the game stream 108. The trailer of a packet, for example, includes data representing the end of the packet, an error correction code, or both. At step 625, after generating packets for each encoded game of the game stream 108, the packetizer transmits each packet of the packetized game stream to a corresponding client system 112 based on a predetermined packet transmission rate. The predetermined packet transmission rate includes, for example, data indicating a predetermined rate to transmit the packets of a packetized game stream (e.g., indicating a number of bits to transmit per second). For example, the packetizer transmits each packet of the packetized game stream according to a periodic time period based on the predetermined packet transmission rate.

Referring again to step 610, in response to the frame rate of the set of game frames (e.g., the frame rate at which the set of game frames was rendered) being lower than a predetermined target frame rate associated with the encoder, the system moves on to step 630. At step 630, the frame rate engine generates one or more skip frames, similar to or the same as skip frames 226. Each skip frame includes, for example, data indicating that a preceding game frame in a game stream is repeated (e.g., maintained). That is to say, a skip frame includes data (e.g., a flag) indicating that a previously encoded frame is to be repeated in a game stream 108. For example, a skip frame includes data indicating that an encoded frame immediately preceding the skip frame is to be repeated. In embodiments, the frame rate engine is configured to generate each skip frame based on one or more codecs used by the encoder to encode the set of game frames. For example, the frame rate engine is configured to determine a type of flag, a value of a flag, a location of a flag, or any combination thereof for a skip frame based on the codec (e.g., H.264, H.265, VP9, AV1) used by the encoder to encode the set of game frames. According to embodiments, the frame rate engine is configured to determine a number of a number of skip frames based on, for example, a difference between the frame requirements associated with the gaming application used to render the set of game frames and the predetermined target frame rate the encoder, a difference between the frame rate of the set of game frames, or both. For example, the frame rate engine is configured to generate a number of skip frames such that a resulting game stream 108 including both encoded game frames of the set of game frames and skip frames has a frame rate equal to the predetermined target frame rate of the encoder. As an example, in response to the set of game frames having a frame rate of and a predetermined target frame rate of the encoder indicating 60 FPS, the frame rate engine is configured to generate a number of skip frames such that a resulting game stream 108 including encoded game frames from the set of game frames and the skip frames is equal to 60 FPS (e.g., the predetermined target frame rate of the encoder).

At step 635 the encoder encodes each game frame of the set of game frames into a game stream 108 according to one or more codecs. For example, the encoder compresses each game frame of the set of game frames by encoding one or more of the differences between the game frame and one or more reference frames into an encoded game frame of a game stream 108. At step 640, the frame rate engine inserts one or more skip frames between two or more encoded frames generated in the game stream 108. According to embodiments, the frame rate engine is configured to insert one or more skip frames between two or more encoded frames based on a difference between the frame requirements associated with the gaming application used to render the set of game frames and the predetermined target frame rate of the encoder, a difference between the frame rate of the set of game frames and the predetermined target frame rate the encoder, or both. For example, in response to the set of game frames having a frame rate of 30 FPS and a predetermined target frame rate of the encoder indicating 60 FPS (e.g., a fixed frame rate of the frame rate engine is configured to insert a skip frame after every encoded game frame. At step 645, the encoder provides the game stream 108 to the packetizer. In response to receiving the game stream 108, the packetizer packetizes each encoded game frame and skip frame of the game stream 108 to produce a packetized game frame (e.g., game stream with skip frames 325). At step 650, after generating packets for each encoded game frame and skip frame of the game stream 108 to produce a packetized game stream, the packetizer transmits each packet of the packetized game stream to a corresponding client system 112 based on the predetermined packet transmission rate.

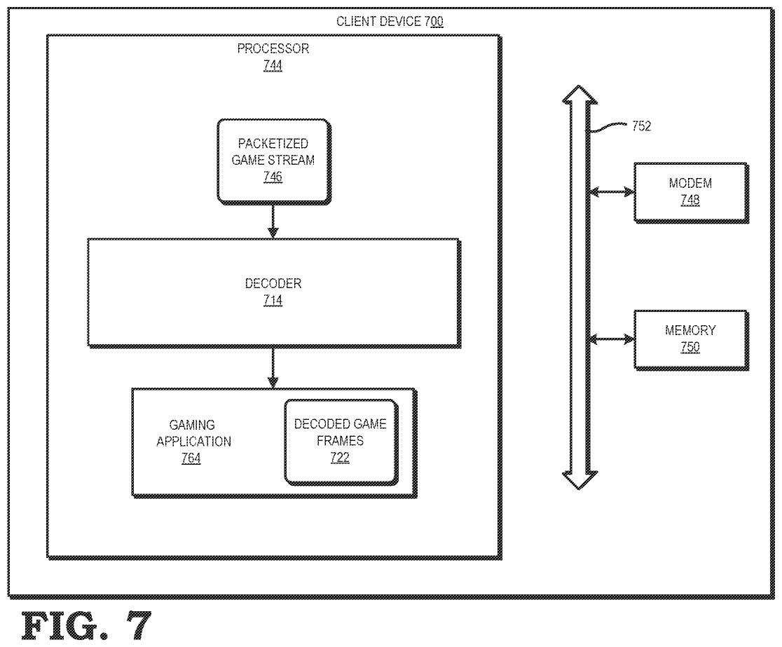

Referring now to FIG. 7, a block diagram of a client device 700 configured to decode and display stream frames within a cloud-based gaming system is illustrated. In embodiments, client device 700 implements aspects of cloud-based gaming system 100 as described in FIG. 1. For example, client device 700 may be part of a client system 112 described in FIG. 1. Client device 700 includes one or more software and hardware components for bi-directional communications including components for decoding a game stream 108 such as to produce a set of decoded game frames 722. In some embodiments, client device 700 is part of an electronic device that supports decoding a gaming stream 108, including, for example, a desktop computer, a notebook computer, a smart phone, a handheld gaming device, a tablet, and a game console, to name a few. In embodiments, client device includes processor 744, modem 748, and memory 750. Memory 750 includes an electronic storage device, such as for example, a solid-state drive, a hard disk drive, RAM, ROM, EEPROM, optical storage device, or any combination thereof. Memory 750 includes instructions and data related to the operation of decoder 714 and gaming application 764 such as, for example, codecs, coefficients, operations, reference frames, gaming engines, operating systems, constants, and the like. Modem 748 is configured to be communicatively coupled to one or more servers 102 via a network 110 and further configured to receive a game stream 108 from the one or more servers 102. According to embodiments, processor 744, modem 748, and memory 750 are internally in electronic communication via one or more interfaces (e.g., a bus 752).

According to embodiments, processor 744 includes one or more CPUs, microprocessors, FPGAs, GPUs, processing cores, or any combination thereof and is configured to decode and display game frames for use in a gaming application 764 associated with a client gaming session on cloud-based gaming system 100. In embodiments, processor 744 includes a decoder 714 capable of decoding one or more game frame from a game stream 108 encoded according to any of the processes and methods discussed above with reference to FIGS. 1-6. In embodiments, decoder 714 is configured to receive a packetized game steam 746 via network 110. Packetized game stream 746 includes, for example, one or more frame packets, similar to or the same as frame packets 505, 515, 525 and one or more skip packets, similar to or the same as skip packets 510, 520, 530. Each frame packet, for example, includes a packetized encoded game frame of a game stream 108 and each skip frame, for example, includes a packetized skip frame of the game stream 108. In response to receiving a packet of a packetized game stream 746, decoder 714 is configured to decode data in the packet based on the type of packet. For example, in response to receiving a frame packet, decoder 714 is configured to decode the encoded frame indicated in the frame packet according to one or more codecs to produce a decoded game frame 722. After decoding a received frame packet into a decoded game frame 722, decoder 714 provides the decoded game frame to game application 764 which is configured to manipulate, modify, and display the decoded game frame 722 on a display such as, for example, display 118. In response to receiving a skip packet, decoder 714 is configured to maintain (e.g., repeat) a previously decoded game frame. For example, decoder 714 is configured repeat the most recent decoded game frame 722 (e.g., the decoded game frame 722 decoded from a frame packet mostly recently received before a skip packet) on a display. In this way, the decoded game frames 722 on display 118 are displayed for a current client gaming session at a frame rate indicated in the predetermined target frame rate of the encoder (e.g., encoder 106, 206) of, for example, a server 102, even when the set of game frames (e.g., set of game frames 250, 305) rendered for the current client gaming session are rendered at a frame rate lower than the predetermined target frame rate of the encoder.

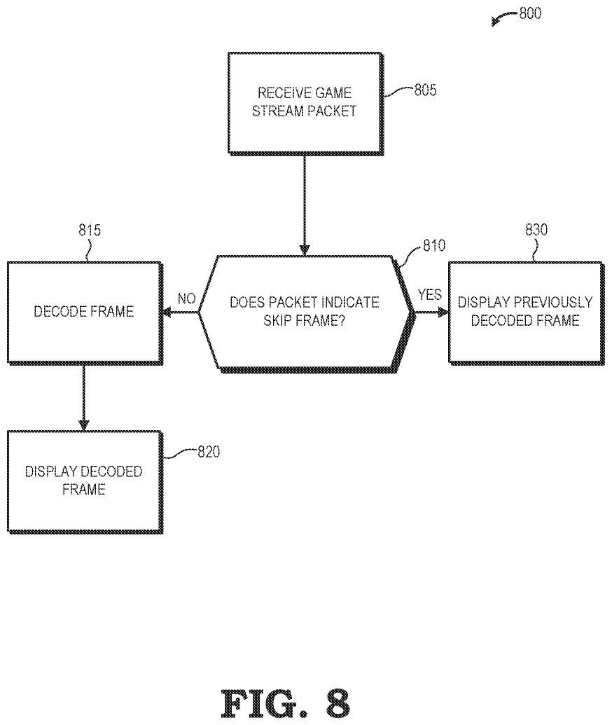

Referring now to FIG. 8, an example method 800 for decoding a packetized game stream including one or more skip packets is presented. At step 805 of the method 800, a client device, similar to or the same as client device 700, receives a packet of a packetized game stream (e.g., packetized game stream 230) from one or more servers 102. At step 810, a decoder, similar to or the same as decoder 714, of the client device determines whether the packet indicates a skip frame. That is to say, the decoder determines whether the received packet is a frame packet (e.g., a packet generated from an encoded game frame), similar to or the same as frame packet 0 505, frame packet 1 515, frame packet N 525, or a skip packet (e.g., a packet generate from a skip frame), similar to or the same as skip packet 510, skip packet 1 520, and skip packet N 530. In response to determining the received packet does not indicate a skip frame (e.g., the received packet is a frame packet), the system moves to step 815. At step 815, the decoder decodes an encoded game frame indicated in the received packet according to one or more codecs to produce a decoded frame, similar to or the same as decoded frames 722. At step 820, the decoder provides the decoded game frame to a game application, similar to or the same as game application 764, which is configured to manipulate, modify, and display the decoded game frame on a display.

Referring again to step 810, in response to determining the received packet does indicate a skip frame (e.g., the received packet is a skip packet), the system moves to step 830. At step 830, the decoder repeats (e.g., maintains) a previously decoded game frame on a display. For example, the decoder 714 repeats a most recent decoded game frame (e.g., the decoded game frame decoded from a frame packet mostly recently received before a skip packet) on a display.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method comprising:
in response to a first frame rate associated with a set of game frames of a current client gaming session being lower than a second frame rate associated with an encoder, generating a skip frame including data that indicates a game frame from the set of game frames is to be repeated;
encoding, by the encoder, the set of game frames to produce a game stream;
inserting the skip frame in the game stream; and
transmitting the game stream to a client system associated with the current client gaming session.

2. The method of claim 1, further comprising:
packetizing the game stream, wherein packetizing the game stream includes:
generating a skip packet based on the skip frame; and
generating a frame packet based on an encoded game frame of the game stream.

3. The method of claim 2, further comprising:
transmitting the frame packet for a first time period; and
transmitting the skip packet for a second time period.

4. The method of claim 3, wherein the first time period is equal to the second time period.

5. The method of claim 3, further comprising:
emptying at least a portion of a network buffer during the second time period.

6. The method of claim 1, wherein inserting the skip frame comprises:
inserting the skip frame between a first and second encoded game frame of the game stream.

7. The method of claim 6, wherein the skip frame includes data indicating the first encoded game frame is to be repeated.

8. The method of claim 1, wherein the client system is configured to repeat an encoded game frame of the game stream based on the skip frame.

9. The method of claim 1, wherein the skip frame is generated based on a codec associated with the encoder.

10. The method of claim 1, the method further comprising generating two or more skip frames and inserting the two or more skip frames in the game stream, wherein each skip frame is inserted between two or more game frames.

11.-24. (canceled)

25. A computer-implemented method, comprising:
receiving, at a client system associated with a current client gaming session, a packetized game stream including a frame packet and a skip packet;
decoding an encoded game frame indicated in the frame packet to produce a decoded game frame; and
repeating the decoded game frame on a display based on the skip packet.

26. The method of claim 25, wherein the skip packet indicates that the decoded game frame is to be repeated.

27. The method of claim 25, wherein the packetized game stream further includes a second frame packet and a second skip packet.

28.-35. (canceled)

36. A cloud-based gaming system comprising:
one or more cloud-based gaming servers communicatively coupled to one or more client systems, each cloud-based gaming server including:
one or more processors; and
a memory coupled to the one or more processors and storing executable instructions configured to manipulate the one or more processors to perform a method of:
in response to a first frame rate associated with a set of game frames of a current client gaming session being lower than a second frame rate associated with an encoder, generating a skip frame including data that indicates a game frame from the set of game frames is to be repeated;
encoding the set of game frames to produce a game stream;
inserting the skip frame in the game stream; and
providing the game stream for transmission to a client system associated with the current client gaming session.

37. The system of claim 36, the method further comprising:
packetizing the game stream, wherein packetizing the game stream includes:
generating a skip packet based on the skip frame; and
generating a frame packet based on an encoded game frame of the game stream.

38. The system of claim 37, the method further comprising:
transmitting the frame packet for a first time period; and
transmitting the skip packet for a second time period.

39. The system of claim 38, the method further comprising:
emptying at least a portion of a network buffer during the second time period.

40. The system of claim 36, wherein inserting the skip frame comprises:
inserting the skip frame between a first and second encoded game frame of the game stream.
receiving, at a client system associated with a current client gaming session, a packetized game stream including a frame packet and a skip packet;
decoding an encoded game frame indicated in the frame packet to produce a decoded game frame; and
repeating the decoded game frame on a display based on the skip packet.

41. A cloud-based gaming system comprising:
a client system configured for cloud-based gaming communicatively coupled to one or more cloud-based gaming servers, the client system including:
one or more processors; and
a memory coupled to the one or more processors and storing executable instructions configured to manipulate the one or more processors to perform a method of:
receiving, at a client system associated with a current client gaming session, a packetized game stream including a frame packet and a skip packet;
decoding an encoded game frame indicated in the frame packet to produce a decoded game frame; and
repeating the decoded game frame on a display based on the skip packet.

42. The system of claim 41, wherein the skip packet indicates that the decoded game frame is to be repeated.
